(19) United States
(12) Patent Application Publication
(10) Pub. No.: US 2017/0298220 A1
(43) Pub. Date: Oct. 19, 2017

(54) ADDITIVE

(71) Applicant: DUPONT NUTRITION BIOSCIENCES APS, Copenhagen (DK)

(72) Inventors: HANS-PETER HENTZE, Tilst (DK); BJARNE NIELSEN, Silkeborg (DK)

(73) Assignee: Dupont Nutrition Biosciences APS, Copenhagen (DK)

(21) Appl. No.: 15/517,084

(22) PCT Filed: Oct. 9, 2015
(86) PCT No.: PCT/EP2015/073383

§ 371 Date: Apr. 5, 2017

(30) Foreign Application Priority Data
Oct. 17, 2014 (GB) 1418452.7

(51) Int. Cl. C08L 67/02; C08K 5/103

(52) U.S. Cl. CPC C08L 67/02; C08K 5/103

(57) ABSTRACT

This invention describes a polymer composition having reduced torque during processing comprising poly(ethylene terephthalate) (PET) and an internal additive, where the internal additive is a polyglycerol fatty acid ester having a degree of esterification of at least 70% and where the concentration of the internal additive is below 5 wt %. This invention further describes a use of said composition for packaging materials and a use of an internal additive in the processing of the polymer composition as a lubricant and/or an anti-blocker during processing of the polymer, where said internal additive is a polyglycerol fatty acid ester having a degree of esterification of at least 70% and 2-10 glycerol repeating units.

### FIELD OF THE INVENTION

The present invention relates to a polymer composition having reduced torque during processing and reduced surface friction comprising a polymer such as poly(ethylene terephthalate) (PET) and an internal additive. The invention also relates to the use of an internal additive in the processing of the polymer composition as a lubricant and/or an anti-blocker during processing of the polymer. The invention further relates to the use of the polymer composition for packaging materials.

### BACKGROUND OF THE INVENTION

Polyolefins, such as polyethylene and polypropylene, are the largest group of technical polymers, accounting for an annual global production of about 150 million ton per year (t/a). The third largest technical polymer group after polyolefins and poly(vinyl chloride) are polyesters, with an annual production of more than 50 million t/a. Especially poly(ethylene terephthalate) (PET) is a rapidly growing polyester type with increasing significance also for the food packaging market. The main advantages of the use of PET in food packaging, compared to other polymers like polyolefins, are mechanical performance, optical clarity, barrier properties and improved shelf-life.

About 50 million tons of polyesters are produced per year. Therefore polyesters account for approximately 22% of the global polymer production. In addition most bioplastics, bio-based and biodegradable polymers are polyesters, like poly(trimethylene terephthalate) (e.g. Sorona®) and polybutyrate (e.g. Ecoflex®). However, the by far largest and most rapidly growing polyester type is PET, with a global production volume of 40 million t/a and a growth rate of about 6%.

The desired properties of PET for packaging applications are attained from its intrinsic polymer properties. PET has become the packaging material of choice for many food products, owing to its glass-like transparency, a high hardness/weight ratio, recyclability, aroma and gas barrier properties, improving the shelf-life of the food. Therefore PET is rapidly developing also as an alternative to other food packaging materials like polyethylene (PE) and polypropylene (PP), as per article published in the ILSI Report Series ‘Packaging materials 1. Polyethylene terephthalate (PET) for food packaging applications’, International Life Science Institute, 1-16 (2000)

Like for any other engineered polymer, the production and processing of PET requires a variety of additives. Among others these include antistatic and antifogging additives, as well as UV absorbers, acetaldehyde scavengers, nucleation additives, chain extenders, impact modifiers, dispersants, reinforcement fillers, plasticizers and lubricants.

For polyesters used for sensitive applications, like food, beverage, cosmetic and medical packaging, there is a growing demand of food grade additives due to their product safety profile. In addition to a safe product profile, for bio-based polyesters food-grade additives match also the requirements regarding sustainability, renewability and optionally also biodegradability.

In contrast to other polymers, like polyolefins or PVC, the processing temperatures for polyesters, like PET, can be much higher (e.g. 280-320° C.). Therefore the polymer additives for these polymers demand high thermal stability. Polyesters like PET also have a high coefficient of friction and therefore require internal lubricants, for reduction of torque during extrusion, for mold release, as well as for surface lubrication for handling and for improved scratch resistance.

A commonly used internal lubricant for polyesters like PET is pentaerythritol tetrastearate (PETS), which is not food-grade. Erucamide is used as a food-grade additive but shows low thermal stability and thus is not optimal for use together with polyesters.

Polyesters are sensitive to hydrolysis during polymer extrusion in contrast to polyolefins. Therefore the residual water content of e.g. PET before extrusion is typically below 0.025 wt %. However, polyesters can not only react with water during extrusion, but also with hydroxyl groups, leading to polymer degradation by alcoholysis. Typical food-grade polymer additives based on glycerol, like glycerol monostearate (GMS), contain significant amounts of free hydroxyl groups that can react and degrade polyesters under processing conditions. In addition, the comparably high extrusion temperatures (e.g. 300° C. for PET) can lead to degradation of the additive itself. Additives for PET should also have a low volatility, as in some processes the drying of the PET occurs under vacuum at extrusion temperatures.

GB2411656 describes slip additives for polyester polymers such as PET. These slip additives are highly effective in lowering the coefficient of friction of the polymer compound during extrusion without adding color to the PET but maintaining high clarity of the product. The slip agents to be used can be compounds such as compounds with the formula R—C(O)O—R′, where R and R′ represent C₁₋₃₄ hydrocarbons.

However, alternative internal additives are needed which are food-grade, high temperature stable and able to act as internal lubricants in order to reduce torque extrusion, which can be use for sensitive applications, like food, beverages, cosmetics and medical packaging

### OBJECT OF THE INVENTION

It is the object of the present invention to provide an internal additive which is food-grade with high thermal stability and able to act as a lubricant in polymers such as polyesters and hereby reduce the torque during extrusion as well as reducing surface friction.

It is a further object of the present invention to provide a packaging material made from a polymer such as a polyester, which can be used for packaging of sensitive components such as food, beverages, cosmetic and medical products.

### BRIEF DESCRIPTION OF THE DRAWINGS

FIG. 1 illustrates reduction of torque by polyglycerol fatty acid esters during extrusion and surface friction of polymer films.

### DETAILED DESCRIPTION

The object of the invention is solved by a polymer composition having reduced torque during processing and reduced surface friction comprising poly(ethylene terephthalate) (PET) and an internal additive, where said internal additive is a polyglycerol fatty acid ester having a degree of esterification of at least 50% and where the concentration of the internal additive is below 5 wt %.

In one embodiment, the polymer composition comprises PET. This includes all polymeric and copolymeric forms of poly(ethyleneterephthalate). PET is further to include all polymers derived from aromatic diacids including all terephthalate polymers and their derivatives.

This invention describes highly esterified polyglycerol fatty acid esters as food-grade additives having low reactivity with polyesters under processing conditions and with high thermal stability. The low reactivity is based on a high degree of esterification, resulting in a reduced number of free hydroxyl groups and low hydroxyl values.

Typically, polyglycerol fatty acid esters have better thermal stabilities and lower volatility than food-grade additives with lower molecular weight, like many glycerol esters and alkanediol esters.

In one embodiment, the polyglycerol fatty acid esters can be formed by esterification of the polyglycerol units by carboxylic acids like fatty acids.

As is understood by one skilled in the art a polyglycerol fatty acid ester comprises a polyglycerol ‘backbone’ onto which fatty acid side chains are attached.

Polyglycerol fatty acids esters are typically prepared by polymerisation of glycerol to provide one or more polyglycerols to which the fatty acids are then attached. The fatty acids are generally attached by one of two routes. A first route involves the direct attachment of the fatty acid to the polyglycerol. The second route involves inter-esterifying a polyglycerol and a triglyceride thereby transferring fatty acids from the triglyceride to the polyglycerol.

Examples of polyglycerol fatty acid esters are for example but not limited to fully acetylated diglycerol stearate, fully acetylated triglycerol stearate, fully acetylated hexaglycerol stearate, triglycerol stearate, triglycerol behenate, 50%-acetylated diglycerol oleate, 75%-acetylated diglycerol oleate, 100%-acetylated diglycerol oleate, triglycerol laurate, hexaglycerol heptastearate.

The polyglycerol fatty acid esters have a degree of esterification of at least 50%. The degree of esterification needs to be above 50% in order for the polyglycerol fatty acid ester to be able to function properly as an internal additive. When the internal additives are highly esterified the remaining hydroxyl groups are sterically hindered and do not significantly react with the polyester itself under processing conditions.

In a further embodiment, the degree of esterification is at least 70%. In a still further embodiment, the degree of esterification is at least 80%. In a further embodiment, the composition comprises fully esterified polyglycerol fatty acid esters.

In this invention the internal additives are highly esterified. The remaining hydroxyl groups are therefore sterically hindered and do not significantly reduce the molecular weight of the polyester during processing. However, as lubricants they can reduce the extrusion torque, and/or the extrusion pressure. In this way they enable energy savings during processing and better processability by reducing also surface friction, e.g. for mold release, processing or handling of final products.

In the polymer composition the concentration of the internal additive is below 5 wt %. Hereby, is to be understood that the weight of the internal additive comprises 5% or less of the total weight of the polymer composition. If the concentration of the internal additive is too high this could alter the mechanical properties of the polymer matrix.

In a further embodiment, the concentration of said internal additive is 0.1-5 wt %. In a still further embodiment, the concentration of said internal additive is 0.3-3 wt %. In a still further embodiment, the concentration of said internal additive is 0.5-3 wt %.

In a further embodiment, the fatty acid chain length is C2-C24. In a still further embodiment, the fatty acid chain length is C12-C22. In a still further embodiment, the fatty acid chain length is C14-C24. In a still further embodiment, the fatty acid chain length is C16-C24. In a still further embodiment, the fatty acid chain length is C10-C16.

These chain lengths are particularly advantageous in combination with food or foodstuff since they are all edible fatty acids.

It is implicitly to be understood that both saturated and unsaturated fatty acids can be used as part of the polyglycerol fatty acid ester.

Furthermore, a mixture of saturated and unsaturated fatty acids can be used in the formation of the polyglycerol fatty acid esters.

Furthermore, a mixture of different chain lengths of fatty acids can be used for the internal additive. Hereby is to be understood that the internal additive added to a polymer composition can comprise fatty acids with different chain lengths.

The fatty acids can be both saturated and unsaturated fatty acids such as but not limited to propionic acid, butyric acid, valeric acid, caproic acid, enathic acid, caprylic acid, pelargonic acid, capric acid, undecylic acid, luric acid, tridecylic acid myristic acid, pentadecylic acid, palmitic acid, margaric acid, staric acid, nonadecylic acid, arachidic acid, heneicosylic acid, behenic acid, tricosylic acid, lignoceric acid, α-linolenic acid, stearidonic acid, eicosapentaenoic acid, docosahexaenoic acid, linoleic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid, mead acid, ricinoleic acid, dihydroxystearic acid.

In a further embodiment, the composition is in a form of a solid, a paste or a liquid.

In a further embodiment, the hydroxyl value is below 750. In a further embodiment, the hydroxyl value is below 500. In a further embodiment, the hydroxyl value is below 400. In a further embodiment, the hydroxyl value is below 350. In a further embodiment, the hydroxyl value is below 200. In a further embodiment, the hydroxyl value is below 100.

In addition, polyesters need internal additives with low reactivity, e.g. a low number of hydroxyl groups in order to avoid transesterification reactions or hydrolysis during processing.

A low hydroxyl value relates to a low number of accessible hydroxyl groups. Thus, a relatively low value is beneficial in preventing the internal additive from binding to the polyester during processing.

The hydroxyl value is related to the number of hydroxyl-groups in the polyglycerol fatty acid esters and can be measured by the JECFA method, based on AOCS Method Cd 13-60.

In a further embodiment, the number of glycerol units is 2-10. In a still further embodiment, the number of glycerol units is 2-5. In a still further embodiment, the number of glycerol units is 2-3. In a still further embodiment, the number of glycerol units is 4-5.

In a further embodiment, the number of glycerol units in said polyglycerol is at least two. Hereby, it is to be understood that the number of glycerol units condensed to form the polyglycerol is at least two. Thus, two glycerol units can be condensed to form the polyglycerol, three glycerol units can be condensed to form the polyglycerol, four glycerol units can be condensed to form the polyglycerol, five glycerol units can be condensed to form the polyglycerol and so forth up till condensation of ten glycerol units in order to form a polyglycerol.

In one embodiment, the polyglycerol is a diglycerol. In a further embodiment, the polyglycerol is a triglycerol. In a still further embodiment, the polyglycerol is a tetraglycerol. In a still further embodiment, the polyglycerol is a pentaglycerol. In a still further embodiment, the polyglycerol is a hexaglycerol. In a still further embodiment, the polyglycerol is a heptaglycerol. In a still further embodiment, the polyglycerol is an octaglycerol. In a still further embodiment, the polyglycerol is a nanoglycerol. In a still further embodiment, the polyglycerol is a decaglycerol.

In one embodiment, the polyglycerol is a mixture of two or more different polyglycerols. Hence, the internal additive may comprise for example a mixture of diglycerols and triglycerols; diglycerols and tetraglycerols; diglycerols, triglycerols and tetraglycerols; diglycerols and pentaglycerols and so forth.

Furthermore, it is to be understood that polyglycerol is to be interpreted as a polyglycerol having x glycerol units but also comprising smaller amounts of e.g. (x−1), (x−2), (x+1) and (x+2) glycerol units. X is to be understood as the number of glycerol units condensed.

Polyglycerols may be linear, branched or cyclic in structure. Generally, all three types of polyglycerol structure may be present in the composition of the present invention. In one embodiment, the polyglycerol is linear. In one embodiment, the polyglycerol is branched. In one embodiment, the polyglycerol is cyclic.

The processes for making polyglycerols are well known to the person skilled in the art and can be found, for example in “Emulsifiers in Food Technology”, Blackwell Publishing, edited by R J Whithurst, page 110 to 130.

In a further embodiment, the internal additive has high thermal stability with less than 25% weight loss at 300° C. as determined by thermogravimetric analysis (TGA).

It is important for the invention that the internal additive to be mixed with the polymer i.e. PET is thermally stable since the internal additive is to be heated during the extrusion process of the polymer compound.

In a further embodiment, the water content of said internal additive is below 1 wt %.

In order for the internal additive to function most efficiently it is important that the polyglycerol fatty acid esters do not comprise too much water since this will impair the extrusion process as it induces hydrolysis of the polyester.

In a further embodiment, the residual glycerol and polyglycerol content of said internal additive is below 7 wt %, preferably below 5 wt %.

By residual glycerol and polyglycerol content are to be understood non-reacted pure glycerol or polyglycerol, which is a contamination of the polyglycerol fatty acid ester. This non-reacted pure glycerol or polyglycerol will react with the polymer such as the PET and hereby counteract the effect of the esterification. Thus, this value is to be as low as possible. A level below 7 wt % is approved for food applications but preferably this value is even lower.

In a further embodiment, the fatty acids are a combination of acetate (C2) and saturated and/or unsaturated fatty acids with C10-C22 where the molar ratio of said fatty acids are N(C2)>N(Cx), where x is any carbon number larger than 2.

The acetyl groups cap free hydroxyl groups. The acetyl group is relatively small and thus reacts more easily with residual hydroxyl groups. Furthermore, the acetyl groups enable the formation of liquid polyglycerol fatty acid esters.

This invention further describes a method of making a polyester compound by mixing poly(ethylene terephthalate) (PET) and an internal additive to form a composition as described herein and hereafter extruding said composition into a polyester compound.

The internal additives can be mixed with the PET in a number of ways known by the persons skilled in the art. The internal additives can be applied directly by coextrusion, during compounding or via masterbatches.

Furthermore, a method is described where the PET and said internal additive are mixed during the extrusion process.

In one embodiment, liquid additives could be dosed directly into the extruder. This might result in a better process control.

This invention further describes a use of an internal additive in a polymer composition, where said internal additive is a polyglycerol fatty acid ester having a degree of esterification of at least 50% and 2-10 glycerol repeating units as a lubricant and/or an anti-blocker during processing of the polymer.

The polymer is a polyester. In a further use, the polymer composition is a polyester such as poly(trimethylene terephthalate) (e.g. Sorona®) and polybutyrate (e.g. Ecoflex®).

In a still further use, the polymer is poly(ethylene terephthalate) (PET). In a still further use, the polymer composition comprises PET. This includes all polymeric and copolymeric forms of poly(ethylene terephthalate). PET is further to include all polymers derived from aromatic diacids including all terephthalate polymers and their derivatives.

By lubricant is meant a compound, which reduces forces between moving surfaces, indicated e.g. by torque reduction during extrusion and/or a reduced coefficient of friction of the polymer surface after production.

The term anti-blocker or antiblocking agent is to be understood as a compound reducing the adhesion or bonding of two surfaces of polymer film, which occur after production and/or during storage.

In a further use the torque during processing is reduced. Hereby is to be understood that polymers such as particularly polyesters cause high mechanical resistance during extrusion causing high torque values of the extrusion screw. Hereby extrusion pressures and energy use rise. Thus efficient lubrication during extrusion improves both processability and energy consumption.

In a still further use the surface friction during processing is reduced. Hereby is to be understood that polymers such as particularly polyesters show a high coefficient of friction, which can lead to blocking, nesting and scratching when the polyester slides against surfaces. Polyglycerol fatty acid esters used as internal lubricants reduce the coefficient of friction of the polyester surface and therefore contribute to surface lubrication of polyesters.

This invention describes the use of highly esterified polyglycerol fatty acid esters as food-grade additives having low reactivity with polymers such as polyesters under processing conditions and with high thermal stability. The low reactivity is based on a high degree of esterification, leading to a reduced number of free hydroxyl groups and low hydroxyl values.

Typically, polyglycerol fatty acid esters have better thermal stabilities and lower volatility than food-grade additives with lower molecular weight, like many glycerol esters and alkanediol esters.

In one use, the polyglycerol fatty acid ester can be formed by esterification of the polyglycerol units by carboxylic acids like fatty acids.

As is understood by one skilled in the art a polyglycerol fatty acid ester comprises a polyglycerol ‘backbone’ onto which fatty acid side chains are attached.

Polyglycerol fatty acid esters are typically prepared by polymerisation of glycerol to provide one or more polyglycerols to which the fatty acids are then attached. The fatty acids are generally attached by one of two routes. A first route involves the direct attachment of the fatty acid to the polyglycerol. The second route involves inter-esterifying a polyglycerol and a triglyceride thereby transferring fatty acids from the triglyceride to the polyglycerol.

Examples of polyglycerol fatty acid ester are for example but not limited to fully acetylated diglycerol stearate, fully acetylated triglycerol stearate, fully acetylated hexaglycerol stearate, triglycerol stearate, triglycerol behenate, 50%-acetylated diglycerol oleate, 75%-acetylated diglycerol oleate, 100%-acetylated diglycerol oleate, triglycerol laurate, hexaglycerol heptastearate.

The polyglycerol fatty acid esters have a degree of esterification of at least 50%. The degree of esterification needs to be above 50% in order for the polyglycerol fatty acid ester to be able to function properly as an internal additive. When the internal additives are highly esterified the remaining hydroxyl groups are sterically hindered and do not significantly react with the polymer such as polyester itself under processing conditions.

In a further use, the degree of esterification is at least 70%. In a still further use, the degree of esterification is at least 80%. In a further use, the composition comprises fully esterified polyglycerol fatty acid esters.

In this invention the internal additives are highly esterified. The remaining hydroxyl groups are therefore sterically hindered and do not significantly reduce the molecular weight of the polyester during processing. However, as lubricants they can reduce the extrusion torque, and/or the extrusion pressure. In this way they enable energy savings during processing and better processability by reducing surface friction, e.g. processing or handling of final products.

In the polymer composition the concentration of the internal additive is below 5 wt %. Hereby, is to be understood that the weight of the internal additive comprises 5% or less of the total weight of the polymer composition. If the concentration of the internal additive is too high this could alter the mechanical properties of the polymer matrix.

In a further use, the concentration of said internal additive is 0.1-5 wt %. In a still further use, the concentration of said internal additive is 0.3-3 wt %. In a still further use, the concentration of said internal additive is 0.5-3 wt %.

In a further use, the fatty acid chain length of said polyglycerol fatty acid esters is C2-C24. In a still further use, the fatty acid chain length is C12-C24. In a still further use, said fatty acid chain length is C14-C22. In a still further embodiment, the fatty acid chain length is C14-C24. In a still further embodiment, the fatty acid chain length is C16-C24. In a still further embodiment, the fatty acid chain length is C12-C18.

These chain lengths are particularly advantageous in combination with food or foodstuff since they are all edible fatty acids.

It is implicitly to be understood that both saturated and unsaturated fatty acids can be used as part of the polyglycerol fatty acid ester.

Furthermore, a mixture of saturated and unsaturated fatty acids can be used in the formation of the polyglycerol fatty acid ester.

Furthermore, a mixture of different chain lengths of fatty acids can be used for the internal additive. Hereby is to be understood that the internal additive added to a polymer composition can comprise fatty acids with different chain lengths.

The fatty acids can be both saturated and unsaturated fatty acids such as but not limited to propionic acid, butyric acid, valeric acid, caproic acid, enathic acid, caprylic acid, pelargonic acid, capric acid, undecylic acid, luric acid, tridecylic acid myristic acid, pentadecylic acid, palmitic acid, margaric acid, staric acid, nonadecylic acid, arachidic acid, heneicosylic acid, behenic acid, tricosylic acid, lignoceric acid, α-linolenic acid, stearidonic acid, eicosapentaenoic acid, docosahexaenoic acid, linoleic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid, mead acid, ricinoleic acid, dihydroxystearic acid.

In a further use, the hydroxyl value is below 750. In a further use, the hydroxyl value is below 500. In a further use, the hydroxyl value is below 400. In a further use, the hydroxyl value is below 350. In a further use, the hydroxyl value is below 200. In a further use, the hydroxyl value is below 100.

In addition, polyesters need internal additives with low reactivity, e.g. a low number of hydroxyl groups in order to avoid transesterification reactions or hydrolysis during processing.

A low hydroxyl value relates to a low number of accessible hydroxyl groups. Thus, a relatively low value is beneficial in preventing the internal additive from binding to the polymer such as polyester during processing.

The hydroxyl value is related to the number of hydroxyl-groups in the polyglycerol fatty acid esters and can be measured by the JECFA method, based on AOCS Method Cd 13-60.

In a further use, the number of glycerol units is 2-5. In a still further use, the number of glycerol units is 2-3. In a still further use, the number of glycerol units is 4-5.

In a further use, the number of glycerol units in said polyglycerol is at least two. Hereby, it is to be understood that the number of glycerol units condensed to form the polyglycerol is at least two. Thus, two glycerol units can be condensed to form the polyglycerol, three glycerol units can be condensed to form the polyglycerol, four glycerol units can be condensed to form the polyglycerol, five glycerol units can be condensed to form the polyglycerol and so forth up till condensation of ten glycerol units in order to form a polyglycerol.

In one use, the polyglycerol is a diglycerol. In a further use, the polyglycerol is a triglycerol. In a still further use, the polyglycerol is a tetraglycerol. In a still further use, the polyglycerol is a pentaglycerol. In a still further use, the polyglycerol is a hexaglycerol. In a still further use, the polyglycerol is a heptaglycerol. In a still further use, the polyglycerol is an octaglycerol. In a still further use, the polyglycerol is a nanoglycerol. In a still further use, the polyglycerol is a decaglycerol.

In one use, the polyglycerol is a mixture of two or more different polyglycerols. Hence, the internal additive may comprise for example a mixture of diglycerols and triglycerols; diglycerols and tetraglycerols; diglycerols, triglycerols and tetraglycerols; diglycerols and pentaglycerols and so forth.

Furthermore, it is to be understood that polyglycerol is to be interpreted as a polyglycerol having x glycerol units but also comprising smaller amounts of e.g. (x−1), (x−2), (x+1) and (x+2) glycerol units. X is to be understood as the number of glycerol units condensed.

Polyglycerols may be linear, branched or cyclic in structure. Generally, all three types of polyglycerol structure may be present in the composition of the present invention. In one use, the polyglycerol is linear. In one use, the polyglycerol is branched. In one use, the polyglycerol is cyclic.

The processes for making polyglycerols are well known to the person skilled in the art and can be found, for example in “Emulsifiers in Food Technology”, Blackwell Publishing, edited by R J Whithurst, page 110 to 130.

In a further use, the internal additive has high thermal stability with less than 25% weight loss at 300° C. as determined by thermogravimetric analysis (TGA).

It is important for the invention that the internal additive to be mixed with the polymer such as a polyester is thermally stable since the internal additive is to be heated during the extrusion process of the polymer compound.

In a further use, the water content of said internal additive is below 1 wt %.

In order for the internal additive to function most efficiently it is important that the polyglycerol fatty acid esters do not comprise too much water since this will impair the extrusion process as it induces hydrolysis of the polyester.

In a further use, the internal additive is a solid, a paste or a liquid.

In a further use, the residual glycerol and polyglycerol content of said internal additive is below 7 wt %, preferably below 5 wt %.

By residual glycerol and polyglycerol content are to be understood non-reacted pure glycerol or polyglycerol, which is a contamination of the polyglycerol fatty acid ester. This non-reacted pure glycerol or polyglycerol will react with the polymer such as the polyester and hereby counteract the effect of the esterification. Thus, this value is to be as low as possible. A level below 7 wt % is approved for food applications but preferably this value is even lower.

In a further use, the fatty acids are a combination of acetate (C2) and saturated and/or unsaturated fatty acids with C10-C22 where the molar ratio of said fatty acids are N(C2)>N(Cx), where x is any carbon number larger than 2.

The acetyl groups cap free hydroxyl groups. The acetyl group is relatively small and thus reacts more easily with residual hydroxyl groups. Furthermore, the acetyl groups enable the formation of liquid polyglycerol fatty acid esters.

This invention further describes the use of a polymer composition as described herein for packaging materials. By packaging material is to be understood besides general food packaging for example flexible pouches, peelable seals, lids and barrier films.

In a further aspect, the packaging material is used for IT components.

Additionally, the polymer composition can be used for industrial applications such as hot stamping foil, photo-resist films, metallic yarns, adhesive tapes, plastic cards, labels and liners, lamination films, brightness enhancement films, solar and safety window films, vacuum insulation panels and films for transfer printing; thermal transfer ribbons such as bar code printers, fax printers, portable printers, ticketing machines, monochrome ribbons and colour ribbons; imaging film such as digital imaging, overhead transparencies, printing and pre-press films, colour proofing, printing plates and wide-format displays; and photovoltaic films

The polymer composition can also be used in connection with electrical applications such as transformer insulation films, membrane touch switches, computer and calculator keyboards, flexible printed circuit films, and flat cables.

Glycerides and polyglycerol fatty acid esters are popular for sensitive applications owing to their sustainability and product safety profile.

The packaging includes any type of food like for example frozen foods and fresh foods.

Besides food packaging, the polymer composition can be used for other sensitive applications such as cosmetic or medical applications like containers and medical packaging due to the sustainability of the products i.e. renewability, product safety and patient health e.g. to replace additives of concern.

In a still further use, the packaging material is a container. Hereby, is to be understood that the packaging material can be for example a box, bin, silo, reservoir and/or barrel capable of holding an object and/or a fluid.

In a still further aspect, the packaging material is a bottle. This could be a bottle for food in the form of beverages. Alternatively, it could be a bottle for other types of food i.e. for example oils, dressings etc.

### Examples

### Materials

Pentaerythritol tetrastearate (PETS) was chosen as a reference sample. It is a non-food grade additive, widely used as a lubricant for polyesters. PETS was compared with a series of polyglycerol fatty acid esters listed in Table 1. All polyglycerol fatty acid esters were characterized by a high degree of esterification, low hydroxyl values and low reactivity with polyesters during extrusion. The additives were blended with polyesters after drying and before extrusion. While most of the additives are solids, some are liquid and could be also used for liquid masterbatches.

TABLE 1
Overview of internal additives for polyesters

| | | | | Sa- | Δm |
|---|---|---|---|---|---|
| | | | Hy- | ponifi- | (30- |
| | | | droxyl | cation | 300° C.) |
| Sample | Additive | Form | value | value | in wt % |
| Reference | pentaerythritol | Solid | — | — | 97 |
| | tetrastearate (PETS) | | | | |
| IPE 1 | fully acetylated | Solid | 1.7 | 415 | — |
| | diglycerol stearate | | | | |
| IPE 2 | fully acetylated | Solid | 3.2 | 317 | 99 |
| | triglycerol stearate | | | | |
| IPE 3 | fully acetylated | Solid | 2.8 | 316 | — |
| | hexaglycerol stearate | | | | |
| IPE 4 | triglycerol stearate | solid | 36.8 | 181 | 98 |
| IPE 5 | triglycerol behenate | solid | 36.8 | 144 | 98 |
| IPE 6 | 50%-acetylated | liquid | 160.9 | 296 | — |
| | diglycerol oleate | | | | |
| IPE 7 | 75%-acetylated | liquid | 79.1 | 353 | 88 |
| | diglycerol oleate | | | | |
| IPE 8 | 100%-acetylated | liquid | 0.0 | 409 | — |
| | diglycerol oleate | | | | |
| IPE 9 | triglycerol laurate | liquid | 50.2 | 232 | 98 |
| IPE 10 | hexaglycerol | solid | 26.7 | 175 | — |
| | heptastearate | | | | |

The additives were applied together with amorphous polyethylene terephthalate (APET). The used APET type is Amite® D04 300 (supplied by DSM), which is transparent and has a medium viscosity.

### Methods

The hydroxyl value is a measure of the content of free hydroxyl groups of a fatty acid ester. It is defined as the number of milligrams of potassium hydroxide equivalent to the hydroxyl content of one gram of polyglycerol fatty acid ester, following AOCS method Cd 13-60.

The saponification value is a measure of the average molecular weight of the fatty acids of a polyglycerol fatty acid ester. It is defined as the number of milligrams of potassium hydroxide required to saponify and neutralize 1 g of polyglycerol fatty acid ester under the conditions specified in AOCS methods TI 1a-64 and Cd 3-25. The lower the average molecular weight of the fatty acids, the higher is the saponification number.

The temperature stability of polymer additives was determined by thermogravimetrical analysis (TGA), according to ISO 11358, using a Perkin Elmer TGA 7 instrument. The samples were heated from 30° C. to 600° C. under nitrogen at a heating rate of 10° C./min. The temperature stabilities of the samples were compared by heating the samples from 30 to 300° C. and determining the weight difference Δm (30-300° C.) in wt %.

### Preparation of APET Films (Related to Examples 1-5)

Before extrusion APET was dried by purging it with dry air for 16 h in a drying oven at 102° C. Subsequently the dried APET pellets were mixed with 1 wt % to 2.5 wt % additive and extruded using a Brabender extruder, Plastograph ID 815606 with a 19/25D screw, type 8322. A flat die, model 628372, was attached to the extruder to produce cast film at an extrusion temperature of 280° C. Subsequently to extrusion the cast films were cooled to 65° C. using a Univex 843303 cooling system and collected at room temperature on rolls. The average thickness of the cast polymer films was 50-60 microns. The torque of the extrusion screw was monitored to determine the lubrication effect of the additives during extrusion. The measurement system is part of the extruder (Plastograph ID 815606).

### Preparation of Sorona® Films (Related to Example 6)

Sorona (poly(trimethylene terephthalate)) pellets were dried before extrusion by purging them with dry air for 16 h in a drying oven at 100° C. Subsequently, the dried Sorona pellets were mixed with 1 wt % additive and extruded using a Brabender extruder, Plastograph ID 815606 with a 19/25D screw, type 8322. A flat die, model 628372, was attached to the extruder to produce cast film at an extrusion temperature of 280° C. Subsequently to extrusion the cast films were cooled to 40° C. using a Univex 843303 cooling system and collected at room temperature on rolls. The average thickness of the cast polymer films was 40-50 microns. The torque of the extrusion screw was monitored to determine the lubrication effect of the additives during extrusion.

The surface lubrication effect of the additives was characterized by coefficient of friction (CoF) measurements using an Instron instrument, model 4301 HO 981. The dynamic coefficient of friction was measured according to a modified ASTM method D 1894-08 for sliding of cast film samples against a metal surface, following Instron Instruction M 10-53-1UK. Before dynamic CoF measurements the film samples were conditioned at ambient conditions for at least 3 days after production.

### Results

As shown in Table 1, the selected highly esterified polyglycerol fatty acid esters are characterized by a high thermal stability (Δm>>80 wt % at 300° C.) and low hydroxyl numbers, qualifying them as potential internal lubricants for polyesters. Their lubrication properties were determined in two ways: a) by measuring the torque reduction during extrusion and b) by measuring their effect on surface friction of the produced polymer films.

When APET was processed without any internal additive the torque during extrusion was very high (see Table 2). PETS is known to be an efficient internal lubricant. When it was added at a concentration of 2.5 wt % it reduced the torque significantly from 23 Nm without additive to only 5 Nm. A similar lubrication effect was also observed for highly esterified polyglycerol fatty acid esters with 2 to 6 glycerol repeating units and fatty acid ester chains with 2 to 22 carbon atoms.

Clear and transparent films were observed for all listed additives, except IPE 10. This film was slightly hazy indicating limited miscibility of polyglycerol fatty acid esters with polyesters with increasing chain length. Due to their low hydroxyl number the melt viscosity of all polymer/additive blends was sufficiently high to obtain dimensional stability of the melt for cast film production. In case of highly esterified polyglycerol fatty acid esters, the torque was largely reduced from 23 Nm without additive to 3-7 Nm.

The best results of torque reduction were not always achieved with the highest degrees of esterification. Samples IPE 6, 7 and 8 were a series of diglycerol oleates with different degrees of acetylation. With increasing degree of acetylation the hydroxyl value was reduced. However, the better lubrication result was observed for the sample with the lowest degree of acetylation. Thus, a small number of remaining free hydroxyl groups may have a beneficial effect for torque reduction.

TABLE 2
Torque reduction by internal food-grade additives during extrusion.

| | | Additive | |
|---|---|---|---|
| | | concen- | |
| | | tration | Torque |
| Additive | Chemical Name | in wt % | in Nm |
| IPE 0 | no additive | — | 23 |
| Reference | pentaerythritol tetrastearate (PETS) | 2.5 | 5 |
| IPE 1 | fully acetylated diglycerol stearate | 2.5 | 5 |
| IPE 2 | fully acetylated triglycerol stearate | 2.5 | 4 |
| IPE 3 | fully acetylated hexaglycerol stearate | 2.5 | 4 |
| IPE 4 | triglycerol stearate | 1 | 3 |
| IPE 5 | triglycerol behenate | 1 | 5 |
| IPE 6 | 50%-acetylated diglycerol oleate | 2.5 | 4 |
| IPE 7 | 75%-acetylated diglycerol oleate | 2.5 | 4 |
| IPE 8 | 100%-acetylated diglycerol oleate | 2.5 | 7 |
| IPE 9 | triglycerol laurate | 1 | 3 |
| IPE 10 | hexaglycerol heptastearate | 2.5 | 5 |

After film production, the films were conditioned at ambient conditions for at least three days. Subsequently the surface friction of the films was measured. The dynamic coefficient of friction for APET without any additive was 0.40. It decreased significantly to 0.16 by using PETS as an internal lubricant. Also food-grade, highly esterified polyglycerol fatty acid esters showed a strong effect regarding reduction of surface friction (Table 3).

TABLE 3
Reduction of surface friction (dynamic
CoF) by internal food-grade additives.

| | | Additive | |
|---|---|---|---|
| | | Concen- | |
| | | tration | dynamic |
| Additive | Chemical Name | in wt % | CoF |
| IPE 0 | no additive | — | 0.40 |
| Reference | pentaerythritol tetrastearate | 2.5 | 0.16 |
| IPE 1 | fully acetylated diglycerol stearate | 2.5 | 0.18 |
| IPE 2 | fully acetylated triglycerol stearate | 2.5 | 0.15 |
| IPE 3 | fully acetylated hexaglycerol stearate | 2.5 | 0.17 |
| IPE 4 | triglycerol stearate | 1 | 0.16 |
| IPE 5 | triglycerol behenate | 1 | 0.22 |
| IPE 6 | 50%-acetylated diglycerol oleate | 2.5 | 0.17 |
| IPE 7 | 75%-acetylated diglycerol oleate | 2.5 | 0.18 |
| IPE 8 | 100%-acetylated diglycerol oleate | 2.5 | 0.22 |
| IPE 9 | triglycerol laurate | 1 | 0.16 |
| IPE 10 | hexaglycerol heptastearate | 2.5 | 0.15 |

By addition of 2.5 wt % or even 1 wt % of food-grade polyglycerol fatty acid esters comparable levels of surface friction were achieved. In case of fully acetylated triglycerol stearate (IPE 2) or hexaglycerol heptastearate (IPE 10) even slightly better results were obtained compared to the non-food grade reference sample.

Samples IPE 4, 5 and 9 represented a series of polyglycerol fatty acid esters with same degree of esterification (85%) and different fatty acid chain lengths. The best lubrication results in this series were observed for the shortest fatty acid chain length of 12 carbon atoms (IPE 9). The dynamic coefficient increased with increasing chain length from 0.16 to 0.22 for 22 carbon atoms chain lengths (IPE 5). Together with the results from the systematic variation of the degree of esterification (IPE 6, 7, 8) this indicates that the lubrication performance can be optimized by a systematic variation of both fatty acid chain length and degree of esterification.

Owing to high thermal stability, good chemical compatibility and the very good lubrication properties, the additives described in this invention are excellent lubricants for PET as shown in Table 2 and Table 3. However, owing to the chemical similarities of polyesters (having ester groups in the polymer backbone), the use of the described additives as lubricants is not limited to PET. They can be also applied for other polyesters, like Sorona® (polytrimethylene terephthalate). This is demonstrated by the data in Table 4 and Table 5 below, which show the highly effective extrusion torque reduction and surface lubrication for Sorona® polymer films. In contrast to PET, here the best results have been achieved using triglycerol stearate (CoF=0.15), giving a 44% reduction of surface friction compared to the reference without additive (CoF=0.27) and a 17% reduction compared to PETS (CoF=0.18) as a commercial, non-food grade reference additive.

TABLE 4
Torque reduction by internal lubricants during Sorona processing:

| | | Additive | |
|---|---|---|---|
| | | concen- | |
| | | tration | Torque |
| Additive | Chemical Name | in wt % | in Nm |
| IPE 0 | no additive | — | 37 |
| Reference | pentaerythritol tetrastearate (PETS) | 1.0 | 2.2 |
| IPE 2 | fully acetylated triglycerol stearate | 1.0 | 1.8 |
| IPE 4 | triglycerol stearate | 1.0 | 1.8 |

TABLE 5
Reduction of surface friction (dynamic CoF)
of Sorona by internal food-grade additives.

| | | Additive | |
|---|---|---|---|
| | | concen- | |
| | | tration | dynamic |
| Additive | Chemical Name | in wt % | CoF |
| IPE 0 | no additive | — | 0.27 |
| Reference | pentaerythritol tetrastearate (PETS) | 1.0 | 0.18 |
| IPE 2 | fully acetylated triglycerol stearate | 1.0 | 0.17 |
| IPE 4 | triglycerol stearate | 1.0 | 0.15 |

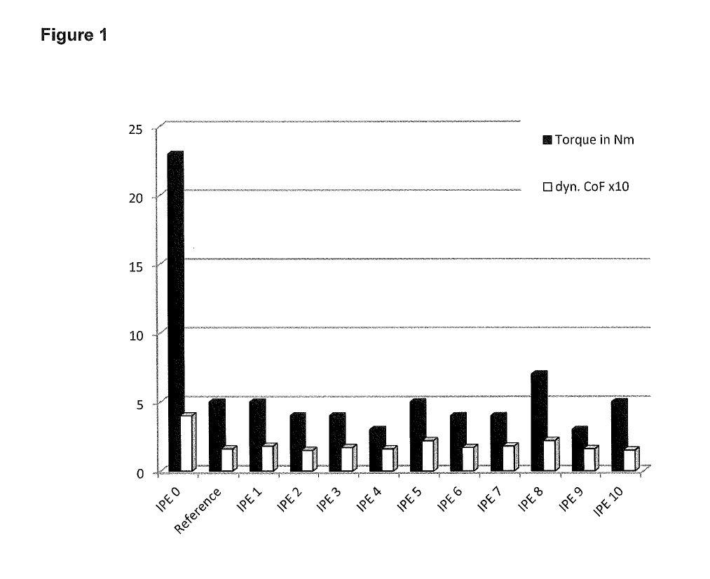

FIG. 1 illustrates the lubrication effect of polyglycerol fatty acid esters for both torque reduction and surface lubrication.

The Examples 1-5 below describe in further detail some of the experiments, the results of which are shown in the Tables 2 and 3.

### Example 1: Coextrusion of APET with 2.5 wt % of Hexaglycerol Heptastearate (IPE 10)

2.5 wt % of hexaglycerol heptastearate, a solid, wax-like material, was mixed with 97.5 wt % of APET pellets and coextruded at 280° C. Addition of hexaglycerol heptastearate reduced the extrusion torque from 23 to 5 Nm. The obtained translucent, slightly hazy polymer film had a surface friction coefficient of 0.15, compared to 0.40 of the corresponding APET film with no additive.

References: 2.5 wt % PETS in APET reduced the torque to 5 Nm and the coefficient of friction to 0.16. 0.5 wt % Erucamide in APET reduced the torque to 4 Nm and the coefficient of friction to 0.19 and the obtained film blocked.

### Example 2: Coextrusion of APET with 2.5 wt % of Fully Acetylated Triglycerol Stearate (IPE 2)

2.5 wt % of fully acetylated triglycerol stearate powder was mixed with 97.5 wt % of APET pellets and coextruded at 280° C. The addition of fully acetylated triglycerol stearate reduced the extrusion torque from 23 to 4 Nm. The obtained, transparent polymer film had a friction coefficient of 0.15 compared to 0.40 of the corresponding APET film with no additive.

### Example 3: Coextrusion of APET with 2.5 wt % of 75%-Acetylated Triglycerol Oleate (IPE 7)

Triglycerol oleate was esterified with acetic anhydride to a degree of acetylation of 75%. 2.5 wt % of the colorless liquid was mixed with 97.5 wt % APET pellets and coextruded at 280° C. The addition of the additive reduced the extrusion torque from 23 to 4 Nm. The obtained, transparent polymer film had a friction coefficient of 0.18, compared to 0.40 of the corresponding APET film with no additive.

### Example 4: Coextrusion of APET with Fully Acetylated Diglycerol Oleate (IPE 8)

2.5 wt % of fully acetylated diglycerol oleate, a colorless liquid, was mixed with 97.5 wt % APET pellets and coextruded at 280° C. The addition of the additive reduced the extrusion torque from 23 to 7 Nm. The obtained, transparent polymer film had a friction coefficient of 0.22 compared to 0.40 of the corresponding APET film with no additive.

### Example 5: Coextrusion of APET with Triglycerol Laurate (IPE 9)

1 wt % of triglycerol laurate, a colorless liquid, was mixed with 97.5 wt % APET pellets and coextruded at 280° C. The addition of the additive reduced the extrusion torque from 23 to 3 Nm. The obtained, transparent polymer film had a friction coefficient of 0.16 compared to 0.40 of the corresponding APET film with no additive.

The Example 6 describes in further detail some of the experiments, the results of which are shown in the Tables 4 and 5.

### Example 6: Coextrusion of Sorona with Triglycerol Stearate (IPE 4)

1.0 wt % of triglycerol stearate, a colorless solid wax, was mixed with 99.0 wt % Sorona pellets and coextruded at 280° C. The addition of the additive reduced the extrusion torque from 37 to 1.8 Nm. The obtained, transparent polymer film had a friction coefficient of 0.15 compared to 0.27 of the corresponding Sorona film with no additive.

Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology, food science or related fields are intended to be within the scope of the claims.

1. A polymer composition, wherein:
the polymer composition comprises poly(ethylene terephthalate) (PET) and an internal additive in a concentration of 0.1-5 wt %;
the internal additive is a polyglycerol fatty acid ester having a chain length of C2-C24, a degree of esterification of at least 70% and 2-5 glycerol units; and
the polymer composition exhibits reduced torque during processing and reduced surface friction relative to an identical composition without the internal additive.

2. The composition according to claim 1, characterized in that, said fatty acid chain length is C10-C16.

3. The composition according to claim 1, characterized in that, said internal additive is a triglycerol ester.

4. The composition according to claim 1, characterized in that, the degree of esterification is at least 80%.

5. The composition according to claim 1, characterized in that, said internal additive has high thermal stability with less than 25% weight loss at 300° C. as determined by thermogravimetric analysis (TGA).

6. The composition according to claim 1, characterized in that, the concentration of said internal additive is 0.5-3 wt %.

7. A method for making a polymer composition, wherein:
the method comprises mixing a polymer and an internal additive;
the polymer composition exhibits reduced torque during processing and reduced surface friction relative to an identical composition without the internal additive;
the internal additive is a polyglycerol fatty acid ester in a concentration of 0.1-5 wt %, having a degree of esterification of at least 70%, 2-5 glycerol repeating units and a fatty acid chain length of C2-C24; and
the internal additive acts as a lubricant and/or an anti-blocker during processing of the polymer.

8. The method according to claim 7, characterized in that, said fatty acid chain length is C12-C18.

9. The method according to claim 7, characterized in that, said internal additive is a triglycerol ester.

10. The method according to claim 7, characterized in that, said polymer is a polyester.

11. The method according to claim 10, characterized in that, said polymer is poly(ethylene terephthalate) (PET).

12. The method according to claim 10, characterized in that, said polymer is poly(trimethylene terephthalate).

13. The method according to claim 7, characterized in that, the degree of esterification is at least 80%.

14. The method according to claim 7, characterized in that, said internal additive has high thermal stability with a thermogravimetric analysis (TGA) of less than 25% weight loss at 300° C.

15. A packaging material comprising a polymer composition as described in claim 1.

16. The packaging material according to claim 15, characterized in that, said packaging material is selected from food, beverage, cosmetic and medical packaging material.
